(19) United States
(12) Patent Application Publication
(10) Pub. No.: US 2012/0118575 A1
(43) Pub. Date: May 17, 2012

(54) Thermally Stable Scale Inhibitor Compositions

(76) Inventor: James Griffin, Kennesaw, GA (US)

(21) Appl. No.: 13/294,887

(22) Filed: Nov. 11, 2011

Related U.S. Application Data
(60) Provisional application No. 61/412,940, filed on Nov. 12, 2010.

(51) Int. Cl. E21B 43/00; C09K 8/528

(52) U.S. Cl. 166/310; 507/227

(57) ABSTRACT

Methods for scale inhibition treatment of oil or gas production wells generally include injecting a scale inhibition composition into the oil or gas production well, wherein the scale inhibition composition comprises one or more polymers, each polymer comprising recurring units of a first monomer and a second monomer, wherein: (i) the first monomer is selected from maleic acid, maleic anhydride, fumaric acid, acrylic acid, salts thereof, or combinations thereof; and (ii) the second monomer is selected from vinyl sulfonic acid, allyl sulfonic acid, methallylsulfonic acid, salts thereof, or combinations thereof; wherein the concentration of the polymers in the composition is about 10 to about 60 percent of the polymers by weight of the composition; and wherein the composition has a pH of about 7 to about 8.5.

### CROSS REFERENCE TO RELATED APPLICATION

This application claims priority to U.S. Provisional Application No. 61/412,940, filed Nov. 12, 2010, which is incorporated herein by reference in its entirety.

### BACKGROUND

The present disclosure generally relates to thermally stable scale inhibitor compositions.

Scale inhibiting polymers are often used in water treatment and oil field applications to minimize and/or prevent scale deposition. The deposition of scale can occur in the transport of aqueous mixtures and in subterranean rock formations due to the presence of water bearing alkaline earth metal cations such as calcium, barium, strontium and the like as well as the presence of anions such as phosphate, sulfates, carbonates, silicates and the like. When these ions are in sufficient concentrations, a precipitate can form that builds up on interior surfaces of the conduits used for transport or in the subterranean rock formations, which restrict flow of the media of interest, e.g., water or oil.

In oilfield applications, scales that are commonly formed include calcium sulfate, barium sulfate, and/or calcium carbonate scales that are generally formed in the fresh waters or brines used in well stimulation as a result of increased concentrations of these particular ions, the water pH, pressures, and temperatures. In addition, calcium phosphate can form in the presence of phosphates commonly used to treat wells and pipes for corrosion. The buildup of these mineral precipitates can reduce or block flow in the conduits and rock formations as well as cause other problems. In many cases, the first warning of the existence of a significant scale deposit may be a decline in well performance. In these instances, scale removal techniques may become necessary. As a result, a potentially substantial cost including downtime is required to effect repair as a result of scaling.

Scale inhibiting materials are commonly applied to rock formations by means of a “squeeze treatment” prior to production. In these applications, a relatively concentrated form of the scale inhibitor is added, typically greater than 10% by weight. Using the method, the scale inhibitor is pumped into a water-producing zone and attaches to the formation by chemical adsorption or by temperature-activated precipitation. When the well is put back into production, the scale inhibitor leaches out of the formation rock to provide scale inhibition.

Capillary injection is another method for delivering scale inhibiting materials. In capillary injection, a relatively concentrated form of the scale inhibitor composition is continuously pumped into the well during production.

Due to changing patterns of energy usage and availability, exploration and production is occurring at increasing depths. As a result, the chemicals used to enhance oil and gas production are subjected to increasing temperatures (i.e. 170° C. to 230° C.) and pressures (i.e. 25,000 to 30,000 psi), which are generally known to both increase as a function of well depth. Many of the compositions commonly used as scale inhibitors have an acidic pH and are unstable under high temperature and pressure conditions. Under such conditions, these compositions typically became degraded, and produce flocculated particles in some instances, while contributing to significant increases in pH as a function of time.

### BRIEF SUMMARY

In view of the foregoing, there is a need for scale inhibition compositions stable under the high temperature and pressure conditions often experienced in oil and gas well applications.

Disclosed herein is a method for scale inhibition treatment of oil or gas production wells to inhibit scale formation, which method comprises injecting a scale inhibition composition into the oil or gas production well, wherein the scale inhibition composition comprises a polymer, the polymer comprising recurring units of a first monomer and a second monomer, wherein: (i) the first monomer is selected from maleic acid, maleic anhydride, fumaric acid, acrylic acid, salts thereof, or combinations thereof; and (ii) the second monomer is selected from vinyl sulfonic acid, allyl sulfonic acid, methallylsulfonic acid, salts thereof, or combinations thereof; wherein the concentration of the polymer in the composition is about 10 to about 60 percent of the polymer by weight of the composition; and wherein the composition has a pH of about 7 to about 8.5.

The disclosure may be understood more readily by reference to the following detailed description of the various features of the disclosure and the examples included therein.

### BRIEF DESCRIPTION OF THE DRAWINGS

FIG. 1 graphically illustrates calcium sulfate inhibition as a function of concentration of a commercially available scale inhibitor; and

FIG. 2 graphically illustrates calcium sulfate inhibition as a function of concentration of a scale inhibitor composition in accordance with the exemplary embodiments described herein.

### DETAILED DESCRIPTION

The exemplary embodiments described herein are generally directed to compositions and methods for inhibiting or reducing scale formation. Exemplary compositions generally include one or more water soluble polymers, each of which comprises recurring units of a first monomer and a second monomer; and water, wherein the pH of the composition is at about 7 to about 8.5 such that the acidic functionalities of the polymer are neutralized.

The exemplary composition has been found to be highly effective for inhibiting or reducing scale formation in aqueous mediums such as, for example, for inhibiting or reducing formation of calcium sulfate, barium sulfate, and/or calcium carbonate under high temperature and/or high pressure conditions. The compositions can be applied to any surface for the purpose of inhibiting or reducing scale formation. The compositions can be used in oilfield injection and production waters, including topside, downhole, and rock formation squeeze applications at the well site. The composition may provide threshold inhibition of scales, has high calcium and barium tolerance, and provides functioning inhibition downhole under high temperature and high pressure conditions.

### DEFINITIONS

The term “antiscalant” generally refers to chemicals that are applied at substoichiometric levels to interfere with crystal nucleation, growth, and agglomeration. As used herein, the terms “antiscalant,” “antiscalants,” “antiscale agent,” “scale inhibitor” and similar terms are used in their ordinary sense as understood by one skilled in the art, and thus may be use herein to refer to or describe chemical compounds or compositions containing such compounds, where the compounds, when added to an aqueous system, reduce or inhibit the amount of scale and/or rate of formation of scale in the aqueous system, as compared to a system that does not contain the added chemical compound or composition. In this context, the terms “scale” or “mineral scale” refers to insoluble substances such as insoluble salts, that have a tendency to form in aqueous systems such as boiler water, cooling water, seawater (e.g. in oil platform applications), brackish water, oilfield water, municipal treatment plant water, paper mill water, mining water, and industrial treatment plant water.

As used herein, the terms “polymer,” “polymers,” “polymeric,” and similar terms are used in their ordinary sense as understood by one skilled in the art, and thus may be used herein to refer to or describe a large molecule (or group of such molecules) that contains recurring units. Polymers may be formed in various ways, including by polymerizing monomers and/or by chemically modifying one or more recurring units of a precursor polymer. A polymer may be a “homopolymer” comprising substantially identical recurring units form by, e.g., polymerizing a particular monomer. A polymer may also be a “copolymer” comprising two or more different recurring units formed by, e.g., copolymerizing two or more different monomers, and/or by chemically modifying one or more recurring units of a precursor polymer. The term “terpolymer” may be used herein to refer to polymers containing three or more different recurring units. A polymer has a weight average molecule weight of about 500 or greater, and thus may be an oligomer.

The term “treatment of scale” will be understood by those skilled in the art to have a broad and customary meaning that includes using the antiscale compositions to reduce or inhibit the amount of scale and/or reduce the rate of formation of scale in various aqueous systems, as compared to comparable aqueous systems that do not contain the antiscale composition.

Polymers

According to exemplary embodiments, a polymer antiscalant may include one of a variety of polymer antiscalants, including copolymer and terpolymer antiscalants. For example, a polymer antiscalant may be a water soluble polymer comprising recurring units of a first and second monomer. Each polymer may include more than one type of monomer as the first monomer component, and/or more than one type of monomer as the second monomer component. The first monomer may be, for example, an ethylenically unsaturated mono- or di-basic carboxylic acid or anhydride, such as maleic acid, maleic anhydride, fumaric acid, and acrylic acid. The second monomer may be, for example, a compound which comprises a sulfonic acid moiety, such as vinyl sulfonic acid, allyl sulfonic acid, and methallylsulfonic acid.

In one embodiment, the first monomer is an ethylenically unsaturated mono-basic carboxylic acid. In one embodiment, the first monomer is an ethylenically unsaturated di-basic carboxylic acid or anhydride. In one embodiment, the first monomer is maleic acid. In another embodiment, the first monomer is maleic anhydride. In another embodiment, the first monomer is fumaric acid. In another embodiment, the first monomer is acrylic acid.

In one embodiment, the second monomer is vinyl sulfonic acid. In another embodiment, the second monomer is allyl sulfonic acid. In another embodiment, the second monomer is methallylsulfonic acid.

Optionally, the polymer may include additional monomers including, for example, ethylenically unsaturated monomers containing a phosphonate or sulfonate group, including diethyl allyl phosphonate, vinyl phosphonic acid, and sodium styrene sulfonate; or fluorescent monomers. Other optional monomers include acrylamide, methacrylamide, those resulting from incomplete hydrolysis of maleic anhydride, hydroxyethylmethacrylate, methacrylic acid, sodium acrylate, sodium methacrylate, potassium acrylate, potassium methacrylate, ammonium acrylate, and ammonium methacrylate. In certain embodiments, the polymer may further include additional monomers including diethyl allyl phosphonate or vinyl phosphonic acid or sodium styrene sulfonate. While the above-mentioned scale inhibiting monomers are usually comprised in the polymer backbone, other monomers and/or other groups may also be included. For example, the other groups can result from a polymerization initiator or can be end-capping groups, for example phosphorus end-capping groups.

According to the various embodiments, exemplary salts of the monomers include sodium, potassium or other metal ion salts, ammonium salts and organic salts, such as alkylamine and hydroxyalkylamine salts.

In accordance with the various embodiments, the polymer is neutralized by adjusting the pH of the composition to a pH in a range of about 7 to about 8.5.

According to the embodiments, the polymer has a weight average molecular weight to 20000 Daltons; in other embodiments, the weight average molecular weight is 4000 to 10000 Daltons, and in still other embodiments, the weight average molecular weight is 5000 to 5500 Daltons.

According to the embodiments, the amount of the first monomer in the polymer compared to the second monomer is generally about 0.1 to about 100 mole percent, about 5 to about 95 mole percent, about 15 to about 90 mole percent, about 20 to about 85 mole percent, about 30 to about 80 mole percent, about 40 to about 75 mole percent, about 50 to about 70 mole percent, or about 55 to about 65 mole percent.

In a particular embodiment, the first monomer is maleic acid or maleic anhydride and the second monomer is allyl sulfonic acid or salt thereof. The amount of maleic acid or anhydride to an allyl sulfonic acid or salt thereof is generally about 0 to about 100 mole percent. In other embodiments, the amount of maleic acid or maleic anhydride to an allyl sulfonic acid or salt thereof is about 30 to about 80 mole percent, and in still other embodiments, the amount of maleic acid or maleic anhydride to an allyl sulfonic acid or salt thereof is 55 to 65 mole percent.

In the various embodiments, any polymerization method can be used to prepare the polymers. The polymers may be synthesized by methods known in the art, for example as disclosed in International Publication No. WO 2007/075603, which is incorporated by reference in its entirety.

In an exemplary embodiment the polymer may be prepared by a free-radical polymerization method. Exemplary methods include aqueous bulk/dispersion polymerization, solution polymerization, or emulsion polymerization. Preferably, the polymerization process is solution polymerization, wherein water is charged to a reaction vessel fitted with a mechanical stirrer and water condenser and heated to a temperature within a range of 45 to 110° C. One or more polymerization initiators may be added or these may be fed in later. A monomer feed(s), soluble initiator feed and optionally a chain transfer reagent feed are added to the vessel over a period of time.

In embodiments, the polymerization of the monomers can be carried out in the presence of polymerization initiators including, without limitation, ammonium persulfate, sodium persulfate, Vazo initiators, azobisisobutyronitrile (AIBN), organic or inorganic peroxides, cerium ammonium nitrate, perchlorates, and the like. The polymerization initiators are generally in an amount of about 0.01 to about 10 weight percent based on the total weight of the monomers as is appreciated by those skilled in the art.

Compositions and Methods of Use

According to exemplary embodiments, a scale-inhibiting composition may comprise one or more polymers, wherein each polymer comprises recurring units of a first monomer and a second monomer, wherein: (i) the first monomer is selected from maleic acid, maleic anhydride, fumaric acid, acrylic acid, salts thereof, or combinations thereof; and (ii) the second monomer is selected from vinyl sulfonic acid, allyl sulfonic acid, methallylsulfonic acid, salts thereof, or combinations thereof; wherein the concentration of the polymers in the composition is about 10 to about 60 percent of the polymers by weight of the composition; and wherein the composition has a pH of about 7 to about 8.5.

In one embodiment, the scale inhibiting composition comprises a polymer, wherein the polymer comprises recurring units of a first monomer and a second monomer, wherein: (i) the first monomer is selected from maleic acid, maleic anhydride, fumaric acid, acrylic acid, salts thereof, or combinations thereof; and (ii) the second monomer is selected from vinyl sulfonic acid, allyl sulfonic acid, methallylsulfonic acid, salts thereof, or combinations thereof; wherein the concentration of the polymer in the composition is about 10 to about 60 percent of the polymer by weight of the composition; and wherein the composition has a pH of about 7 to about 8.5.

In exemplary embodiments, the concentration of the composition is about 5 to about 90, about 5 to about 80, about 10 to about 70, or about 10 to about 60 percent of the polymer by weight of the composition. For squeeze applications, the compositions are generally about 5 to about 30 percent, about 5 to about 20 percent, about 10 to about 20 percent, or about 15 to about 20 percent of the polymer by weight of the composition. For capillary injection applications, the compositions are generally about 10 to about 50 percent, about 15 to about 45 percent, about 20 to about 40 percent, or about 25 to about 35 percent of the polymer by weight of the composition.

In an embodiment, the compositions are generally about 10, about 15, about 16, about 17, about 18, about 19, about 20, about 21, about 22, about 23, about 24, about 25, about 26, about 27, about 28, about 29, about 30, about 31, about 32, about 33, about 34 or about 35 percent of the polymer by weight of the composition.

According to the embodiments, the scale inhibiting polymer compositions may be used treat scale in any water system in which scale may be likely to form. Exemplary water systems, include, without limitation, cooling tower water systems (including open recirculating, closed and once-through systems); petroleum wells, downhole formations, geothermal wells and other oil field applications; boilers and boiler water systems; mineral process waters including mineral washing, flotation and benefaction; paper mill digesters, washers, bleach plants and white water systems; black liquor evaporators in the pulp industry; gas scrubbers and air washers; continuous casting processes in the metallurgical industry; air conditioning and refrigeration systems; industrial and petroleum process water; indirect contact cooling and heating water, such as pasteurization water; water reclamation and purification systems; membrane filtration water systems; food processing streams (meat, vegetable, sugar beets, sugar cane, grain, poultry, fruit and soybean); and waste treatment systems as well as in clarifiers, liquid-solid applications, municipal sewage treatment and industrial or municipal water systems.

In exemplary embodiments, the scale inhibiting compositions are used in treating scale under high temperature and/or high pressure conditions, for example in oil or gas productions wells. The scale inhibiting compositions may be used to treat scale in conditions wherein the temperature is at least about 170° C. or in the range of about 170 to about 230° C. The scale inhibiting compositions also may be used to treat scale in conditions wherein the pressure is at least about 25,000 psi or in the range of about 25,000 to about 35,000 psi. In a particular embodiment, the scale inhibition treatment is at a temperature of about 170° C. to about 230° C. and a pressure of about 25,000 to 35,000 psi.

In the exemplary embodiments, the scale inhibitor polymer and/or composition may be used in an amount effective to produce any necessary or desired effect. In an exemplary embodiment, an effective amount of the scale inhibitor composition of the embodiments may be dependent on one or more conditions present in the particular system to be treated and scale inhibiting moieties in the scale inhibiting polymer, as would be understood to one of skill in the art. The effective amount may be influenced, for example, by factors such as the area subject to deposition, temperature, water quantity, and the respective concentration in the water of the potential scale and deposit forming species. According to various embodiments, the treatment composition according to the present disclosure will be effective when the scale inhibitor polymer is used at levels less than 500 parts per million (ppm). In some embodiments, the composition is effective at concentrations of about 1 to 100 ppm; and in still other embodiments; the effective concentration is about 1 to about 50 ppm. In certain embodiments, the effective concentration of the polymer is about 10, about 20, about 30, about 40 or about 50 ppm. In various embodiments, the treatment composition can be added directly into the desired aqueous system to be treated in a fixed quantity provided the pH is subsequently adjusted to neutralize the polymer as noted above or can be provided as an aqueous solution and added continuously or intermittently to the aqueous system as can be desired for some applications. The pH of the composition can be adjusted, for example, by the addition of acid or base, or as would be know to one of skill in the art.

By way of example, the compositions of the present embodiments can be used in oilfield injection and production waters by any technique for the delivery of application of scale inhibitors, e.g., via capillary injection, including topside, downhole and rock formation squeeze applications at the well site.

Without being limited by theory, the exemplary embodiments provide the necessary or desired antiscalant function by modifying the crystal growth of nucleating scale particles and interrupting and delaying crystal growth. They also may sequester metal ions, making them unavailable for ion pairing with anions and hence preventing precipitation of insoluble scale.

Many minerals can produce mineral scale, for example calcium carbonate, calcium sulfate, barium sulfate, calcium oxalate, calcium phosphate, silica, calcium silicate, magnesium silicate, fluorosilicate, aluminosilicate, strontium sulfate, calcium fluoride, magnesium hydroxide, and various iron or manganese compounds. The compositions and methods disclosed herein may be used to reduce or inhibit the formation of one or more types of scale, including those described herein.

In one embodiment, the injection of the scale inhibition composition into the oil or gas production well occurs during a squeeze application. In another embodiment, the injection of the scale inhibition composition into the oil and gas production well occurs by capillary injection during production.

In one embodiment, the scale inhibiting polymer composition is utilized in a squeeze application. The scale inhibiting polymer may be diluted in a carrier solvent (usually brine) and propagated out to an optimized radial distance into the oil producing formation, where it is retained and then released slowly back into the aqueous phase during normal well production. In one embodiment, the squeeze process generally includes applying a dilute solution of the scale inhibiting polymer with surfactant (0.1%) to clean and cool the near wellbore. Once cleaned, a high concentration solution of the scale inhibiting polymer at between 5 and 20% is introduced, followed by a low concentration solution of the scale inhibiting polymer. The solutions are left in contact with the reservoir for a period of time effective to allow for adsorption equilibration, after which the well is returned to production. Adhesion to the formation allows the scale inhibiting polymer to remain within the near-wellbore area without being pumped up in the oil/water emulsion. Although squeeze application of the chemical is the most common method of treating downhole scale, the product could also be applied by other techniques commonly used offshore, which include gas-lift injection, downhole annulus injection, encapsulation or soluble matrix techniques, sub-sea wellhead injection via umbilical or indeed secondary topside treatments to enhance inhibitor performance as process conditions vary scaling tendency.

Prior to application of the product, experiments can be conducted in a laboratory to determine an effective minimum inhibitor concentration (MIC) which just inhibits inorganic scale formation under simulated production conditions. The ability of the operator to quickly and accurately determine the amount of scale inhibitor in the produced fluids and compare this to the MIC values generated allows him to decide when it is necessary or desirable to retreat the reservoir or increase the topside addition rate to ensure that no damage occurs to his reservoir or equipment due to inorganic scale deposition.

In one embodiment, a method for scale inhibition treatment of an oil or gas production well comprises injecting a scale inhibition composition into the oil or gas production well, wherein the scale inhibition composition comprises one or more polymers, each polymer comprising recurring units of a first monomer and a second monomer, wherein: (i) the first monomer is selected from maleic acid, maleic anhydride, fumaric acid, acrylic acid, salts thereof, or combinations thereof; and (ii) the second monomer is selected from vinyl sulfonic acid, allyl sulfonic acid, methallylsulfonic acid, salts thereof, or combinations thereof; wherein the concentration of the polymers in the composition is about 10 to about 60 percent of the polymers by weight of the composition; and wherein the composition has a pH of about 7 to about 8.5.

In another embodiment, a method for scale inhibition treatment comprises applying a scale inhibition composition to the surface to be treated, wherein the scale inhibition composition comprises one or more polymer, each polymer comprising recurring units of a first monomer and a second monomer, wherein: (i) the first monomer is selected from maleic acid, maleic anhydride, fumaric acid, acrylic acid, salts thereof, or combinations thereof; and (ii) the second monomer is selected from vinyl sulfonic acid, allyl sulfonic acid, methallylsulfonic acid, salts thereof, or combinations thereof; wherein the concentration of the polymers in the composition is about 10 to about 60 percent of the polymers by weight of the composition; wherein the composition has a pH of about 7 to about 8.5; and wherein the scale inhibition treatment wherein the scale inhibition treatment is at a temperature of at least about 170° C.

According to various embodiments, a composition for scale inhibition comprises one or more polymers, each polymer comprising recurring units of a first monomer and a second monomer, wherein: (i) the first monomer is selected from maleic acid, maleic anhydride, fumaric acid, acrylic acid, salts thereof, or combinations thereof; and (ii) the second monomer is selected from vinyl sulfonic acid, allyl sulfonic acid, methallylsulfonic acid, salts thereof, or combinations thereof; wherein the concentration of the polymers in the composition is about 10 to about 60 percent of the polymers by weight of the composition; and wherein the composition has a pH of about 7 to about 8.5.

The following examples are presented for illustrative purposes only, and are not intended to be limiting.

### Comparative Example 1

In this example, a 30% by weight solution containing a partially neutralized copolymer of maleic acid and sodium allyl sulfonate obtained from Kemira Chemicals, Inc. under the trade name KemGuard 2705 (pH was 5.0) was subjected to a heat treatment study. Samples of the partially neutralized copolymer were placed in an oven and heated to 177° C. over a 7 day period and the pH was periodically measured. The results are provided in Table 1.

TABLE 1

| Time | pH |
|---|---|
| Initial | 5.0 |
| 3 days | 6.6 |
| 7 days | 6.8 |

As shown, a significant increase in pH as a function of time at 177° C. was observed.

### Comparative Example 2

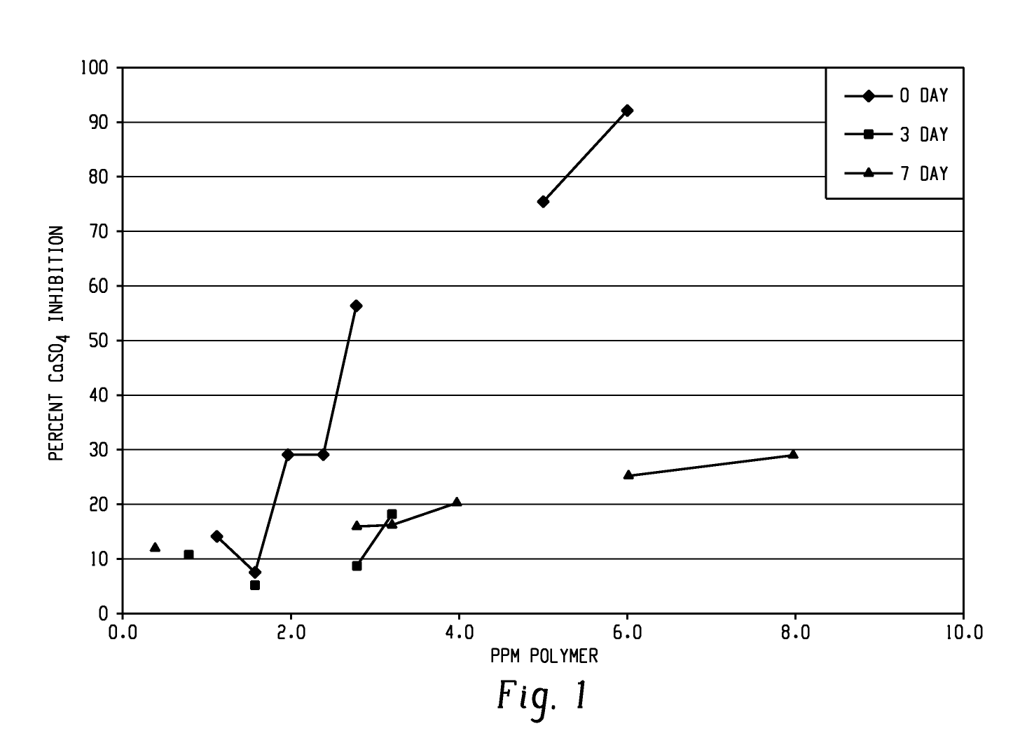

In this comparative example, the calcium sulfate inhibition was measured by a static precipitation method using a supersaturated solution of calcium and sulfate ions for different concentrations of a partially neutralized copolymer of maleic acid and sodium allyl sulfonate obtained from Kemira Chemicals, Inc. under the trade name KemGuard 2705 (pH was 5.0) that had been subjected to oven aging at 177° C. for a period of up to 7 days. The results are graphically shown in FIG. 1.

The test included preparing various standard solutions. First a standard solution of 120 mg/ml sodium sulfate by adding 88.72 grams of sodium sulfate and distilled water to the mark in a 500 mL volumetric flask. Next, a standard solution of 50 mg/ml calcium was prepared by adding 91.70 grams of calcium chloride dihydrate and distilled water to the mark in a 500 mL volumetric flask. This solution was standardized by pipetting 20 ml of solution to a flask and diluting to 500 grams total solution with distilled water and measuring the calcium concentration. A scale inhibitor solution was prepared with distilled water by adding 0.1 gram of inhibitor (sample amount adjusted based on % active of the inhibitor solution) and adding water to the mark in a 100 mL volumetric flask.

The calcium sulfate inhibition test included adding 420 grams of distilled water to a 500 ml tared volumetric flask. To this, was added 20 ml of the standardized sodium sulfate solution followed by mixing; 20 ml of the standardized calcium chloride solution; and additional distilled water to a total solution weight of 500 grams. A control without the scale inhibitor was also formulated. The samples were aged for 24 hours at 60° C. The calcium concentration in solution was then measured, which was then used to calculate the percent inhibition provided by the sample in accordance with the following equation:

$$\% Inhibition = \frac{( P P M calcium in sample - P P M calcium in blank )}{( \begin{matrix}P P M calcium in standardization solution - \\ P P M calcium in blank\end{matrix} )}$$

As shown, heating the copolymer significantly reduced its effectiveness when compared to no heat treatment. Calcium inhibition was about 75% when the copolymer concentration was at 5 ppm. However, calcium inhibition decreased to about 25% after 7 days of aging at 177° C. NMR analysis of the aged copolymer confirmed that the ratio of maleic acid to sodium allyl sulfonate was reduced, thereby confirming heat degradation of the copolymer. GPC analysis also revealed an increase in the molecular weight and polydispersity of the polymer.

### Example 1

In this example, the pH of the composition was varied from 7 to 10 and subsequently aged in an oven at 177° C. for a defined period of time. The composition was a 30% by weight solution of a partially neutralized copolymer of maleic acid and sodium allyl sulfonate obtained from Kemira Chemicals, Inc. under the trade name KemGuard 2705, wherein the pH was adjusted using 45% potassium hydroxide from an initial pH of about 5 to the initial values as shown in Table 2. By adjusting the pH in this manner, the copolymer is believed to have been completely neutralized.

TABLE 2

Ex. No.

| Time | Ex. 1-1 | 1-2 | 1-3 | 1-4 |
|---|---|---|---|---|
| Initial pH | 7 | 8 | 10 | 7.8 |
| pH after 3 days | 7.6 | 8.2 | 9.2 | 8.0 |
| pH after 7 days | 8.2 | 8.4 | 8.6 | 8.2 |

As shown, with the exception of the composition having an initial pH of 10, the pH increased when exposed to 177° C. for an extended period of time. In the case of the composition having the initial pH of 10, the pH decreased as a function of time.

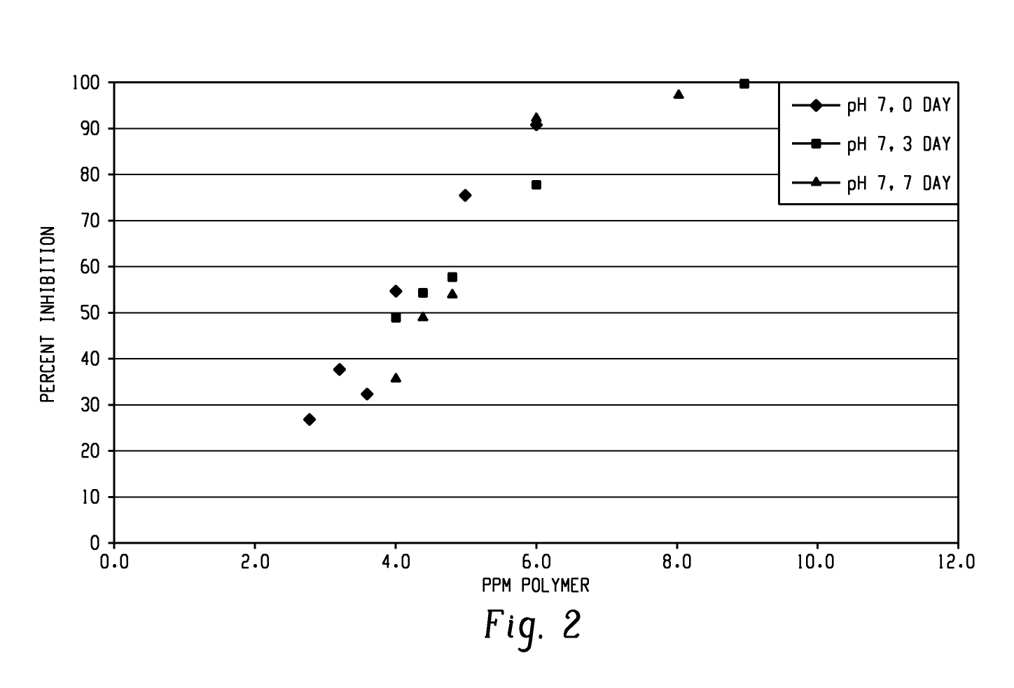

FIG. 2 graphically illustrates calcium sulfate inhibition for the neutralized copolymer of maleic acid and sodium allyl sulfonate having an adjusted pH value of 7. Compared to the initial values, heat treatment unexpectedly did not affect calcium sulfate inhibition.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for scale inhibition treatment of an oil or gas production well comprising injecting a scale inhibition composition into the oil or gas production well, wherein the scale inhibition composition comprises one or more polymers, each polymer comprising recurring units of a first monomer and a second monomer,
wherein:
(i) the first monomer is selected from maleic acid, maleic anhydride, fumaric acid, acrylic acid, salts thereof, or combinations thereof; and
(ii) the second monomer is selected from vinyl sulfonic acid, allyl sulfonic acid, methallylsulfonic acid, salts thereof, or combinations thereof;
wherein the concentration of the polymers in the composition is about 10 to about 60 percent of the polymers by weight of the composition; and wherein the composition has a pH of about 7 to about 8.5.

2. The method of claim 1, wherein the first monomer comprises maleic acid.

3. The method of claim 1, wherein the first monomer comprises maleic anhydride.

4. The method of claim 1, wherein the first monomer comprises fumaric acid.

5. The method of claim 1, wherein the first monomer comprises acrylic acid.

6. The method of claim 1, wherein the second monomer comprises vinyl sulfonic acid.

7. The method of claim 1, wherein the second monomer comprises allyl sulfonic acid.

8. The method of claim 1, wherein the second monomer comprises methallyl sulfonic acid.

9. The method of claim 1, wherein the polymer comprises maleic acid or maleic anhydride and allyl sulfonic acid.

10. The method of claim 1, wherein the injection of the scale inhibition composition into the oil or gas production well occurs during a squeeze application.

11. The method of claim 1, wherein the injection of the scale inhibition composition into the oil and gas production well occurs by capillary injection during production.

12. The method of claim 1, wherein the scale inhibition treatment is at a temperature of at least about 170° C.

13. The method of claim 1, wherein the scale inhibition treatment is at a pressure of at least about 25,000 psi.

14. The method of claim 1, wherein the scale inhibition treatment is at a temperature of about 170 to about 230° C.

15. The method of claim 1, wherein the scale inhibition treatment is at a pressure of about 25,000 to about 35,000 psi.

16. The method of claim 1, wherein the scale inhibition treatment is at a temperature of 170 to 230° C. and a pressure of 25,000 to 35,000 psi.

17. A method for scale inhibition treatment comprising applying a scale inhibition composition to the surface to be treated, wherein the scale inhibition composition comprises one or more polymers, each polymer comprising recurring units of a first monomer and a second monomer,
wherein:
(i) the first monomer is selected from maleic acid, maleic anhydride, fumaric acid, acrylic acid, salts thereof, or combinations thereof; and
(ii) the second monomer is selected from vinyl sulfonic acid, allyl sulfonic acid, methallylsulfonic acid, salts thereof, or combinations thereof;
wherein the concentration of the polymers in the composition is about 10 to about 60 percent of the polymers by weight of the composition; wherein the composition has a pH of about 7 to about 8.5; and
wherein the scale inhibition treatment wherein the scale inhibition treatment is at a temperature of at least about 170° C.

18. A composition for scale inhibition comprising one or more polymer, each polymer comprising recurring units of a first monomer and a second monomer,
wherein:
(i) the first monomer is selected from maleic acid, maleic anhydride, fumaric acid, acrylic acid, salts thereof, or combinations thereof; and
(ii) the second monomer is selected from vinyl sulfonic acid, allyl sulfonic acid, methallylsulfonic acid, salts thereof, or combinations thereof;
wherein the concentration of the polymers in the composition is about 10 to about 60 percent of the polymers by weight of the composition; and wherein the composition has a pH of about 7 to about 8.5.

19. The composition of claim 18, for use in conditions wherein the temperature is at least about 170° C.
